(19) United States
(12) Patent Application Publication
(10) Pub. No.: US 2011/0158246 A1
(43) Pub. Date: Jun. 30, 2011

(54) NETWORK SYSTEM OF DATA COMMUNICATION

(75) Inventors: CHI-CHIH WANG, Tu-Cheng (TW); RUI-JUN WANG, Shenzhen City (CN); XU-KUN WANG, Shenzhen City (CN); YAO-FENG LI, Shenzhen City (CN)

(73) Assignees: GDS SOFTWARE (SHENZHEN) CO.,LTD, ShenZhen City (CN); HON HAI PRECISION INDUSTRY CO., LTD., Tu-Cheng (TW)

(21) Appl. No.: 12/826,712

(22) Filed: Jun. 30, 2010

(30) Foreign Application Priority Data
Dec. 30, 2009 (CN) 200910312685.2

(51) Int. Cl. H04L 12/56

(52) U.S. Cl. 370/401

(57) ABSTRACT

A data communication network system comprises: a data receiving layer which comprises data communication terminals (DCT), a route layer which comprises routers. Each of the routers receives data from the DCTs or from other router 50 of the route layer. The network system further comprise a data receiving layer which comprising a receiver, which receives the data from the routers.

### BACKGROUND

1. Technical Field

Embodiments of the present disclosure generally relate to network deployment, and more specifically to a network system of data communication.

2. Description of Related Art

Nowadays, wireless communication devices based on the ZigBee specification are widely used in industrial device monitoring and data communication fields. The ZigBee specification is for a suite of high level communication protocols using small, low-power digital radios based on the IEEE 802.15.4-2003 standard. The ZigBee specification is intended for use in embedded applications requiring low data rates and low power consumption.

A traditional network system of communicating data using wireless communication devices based on the ZigBee specification adopts a layer 2 network topology, as shown in FIG. 1. The layer 2 network topology includes a router layer 1 and a data receiving layer 2. The router layer 1 consists of special data communication terminals (SDCTs) 10. The SDCT 10 have both routing and data communication functions. The data receiving layer 2 includes a receiver 20. The receiver 20 can receive data from the SDCTs 10 by hardwired connection or wirelessly.

The current layer 2 network topology has the following disadvantages:

1. If an SDCT serving as an important routing node breaks down (power goes down, for example), the SDCT cannot send data to the receiver 20, due to both routing and data communication functions are integrated in the SDCT, and other SDCTs also cannot send data to the receiver 20 due to the routing node break down.
2. An SDCT has a high price, thus, the layer 2 network topology has a high cost.
3. Possible transmission distance is short.
4. Data communicating is easily disturbed by a barrier 3.

### BRIEF DESCRIPTION OF THE DRAWINGS

FIG. 1 is a block diagram of a traditional network system of data communication.

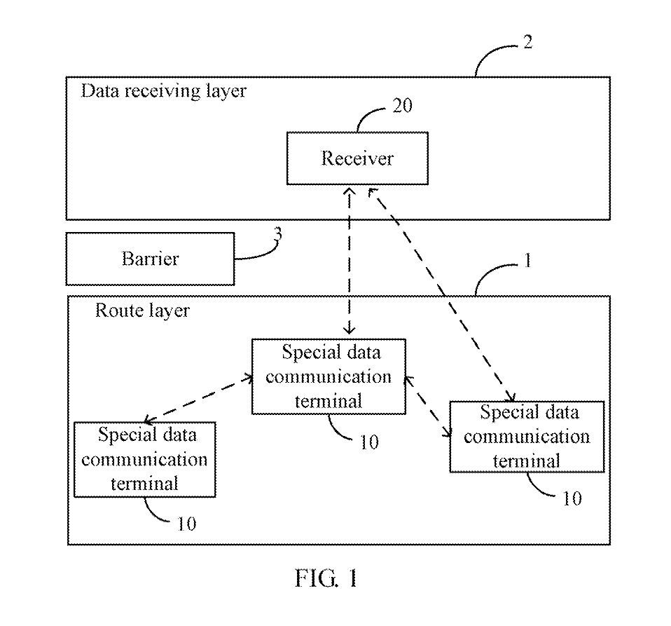

FIG. 2 is a block diagram of one embodiment of a new network system of data communication.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

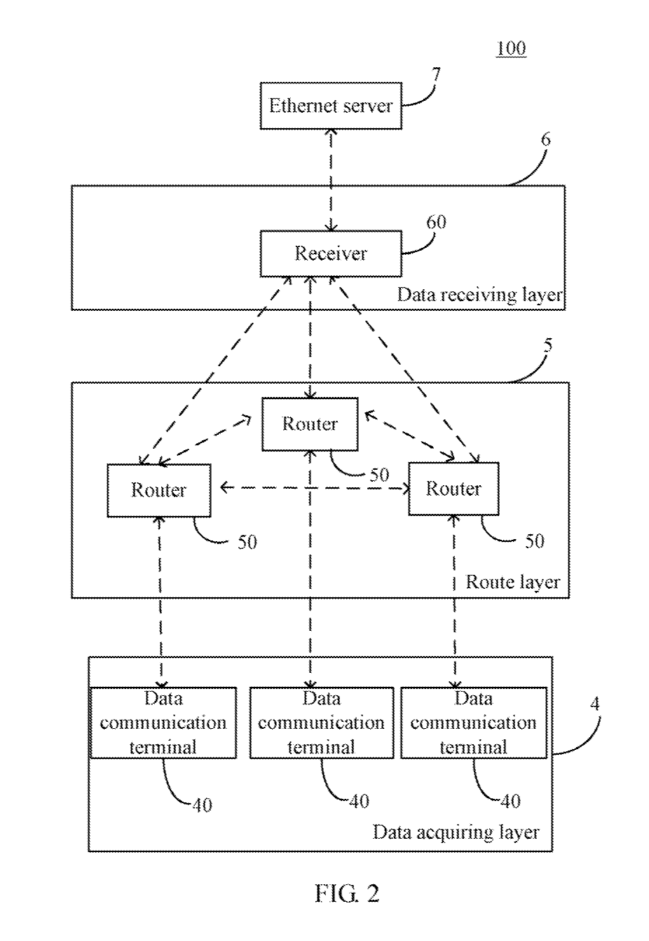

FIG. 2 is a block diagram of one embodiment of a new network system 100 of data communication based on the ZigBee specification . In one embodiment, the network system 100 adopts a layer 3 network topology, including a data acquiring layer 4, a route layer 5, and a data receiving layer 6 all in wireless or hardwired communication with each other.

The data receiving layer 4 includes a plurality of data communication terminals (DCTs) 40, each of which supports the ZigBee specification. In one embodiment, each DCT 40 is installed in an industrial device (not shown in FIG. 2) of a production field at a factory. Each DCT 40 has a data communication function, but has no routing function. Each DCT 40 acquires data from the industrial device, and sends the data to the route layer 5 by hardwired connection or wirelessly.

The route layer 5 includes a plurality of routers 50, each of which supports the ZigBee specification. Each router 50 is placed at a location above the industrial device holding the DCT 40. The location may be a beam of the production field. In one embodiment, a distance between every two routers 50 may be about 30 meters, for example. Each router 50 receives the data from the DCTs 40 or from other router 50, computes a communication route for the data using a routing algorithm according to the ZigBee specification, and sends the data via the communicating route. In one embodiment, two or more of the routers 50 can receive data from the same one DCT 40 or the same one other router 50 at the same time.

The data receiving layer 6 includes a receiver 60. In one embodiment, the receiver 60 includes an Ethernet interface and a radio network interface. The receiver 60 connects to an Ethernet server 7 via the Ethernet interface by hardwired connection, and wirelessly communicates with each of the routers 50 via the radio network interface. The receiver 60 is placed at a location which is higher than the DCTs 40. The location may be high up in the production field, such as mounted to the ceiling, for example.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A data communication network system, comprising:
a data receiving layer comprising a plurality of data communication terminals (DCTs);
a route layer comprising a plurality of routers, each of the routers receiving data from the DCTs or from the other routers of the route layer; and
a data receiving layer comprising a receiver, which receives the data from the routers.

2. The network system as described in claim 1, wherein each of the routers computes a communicating route using a routing algorithm according to the ZigBee specification after receiving the data, and sends the data with the receiver via the communicating route.

3. The network system as described in claim 1, wherein the receiver comprises an Ethernet interface and a radio network interface.

4. The network system as described in claim 3, wherein the receiver connects to an Ethernet server via the Ethernet interface by hardware connection, and communicates with the routers via the radio network interface by wireless.

5. The network system as described in claim 1, wherein each of the DCTs is installed in an industrial device of a production field at a factory.

6. The network system as described in claim 5, wherein each of the routers is placed at a location above the industrial device holding the DCT.

7. The network system as described in claim 6, wherein the location is a beam of the production field.

8. The network system as described in claim 5, wherein the receiver is placed on a location that is higher than the DCTs.

9. The network system as described in claim 8, wherein the location of placing the receiver is high up in the production field.
